(19) United States
(12) Patent Application Publication
(10) Pub. No.: US 2016/0268960 A1
(43) Pub. Date: Sep. 15, 2016

(54) High density photo voltaic arrays or panels

(71) Applicant: Robert Phares Dildine, New Knoxville, OH (US)

(72) Inventor: Robert Phares Dildine, New Knoxville, OH (US)

(21) Appl. No.: 14/544,974

(22) Filed: Mar. 12, 2015

(51) Int. Cl. H02S 20/32; H01L 31/042

(52) U.S. Cl. CPC H02S 20/32; H02S 30/00

(57) ABSTRACT

The idea is to provide more output per footprint area of a solar cell array.

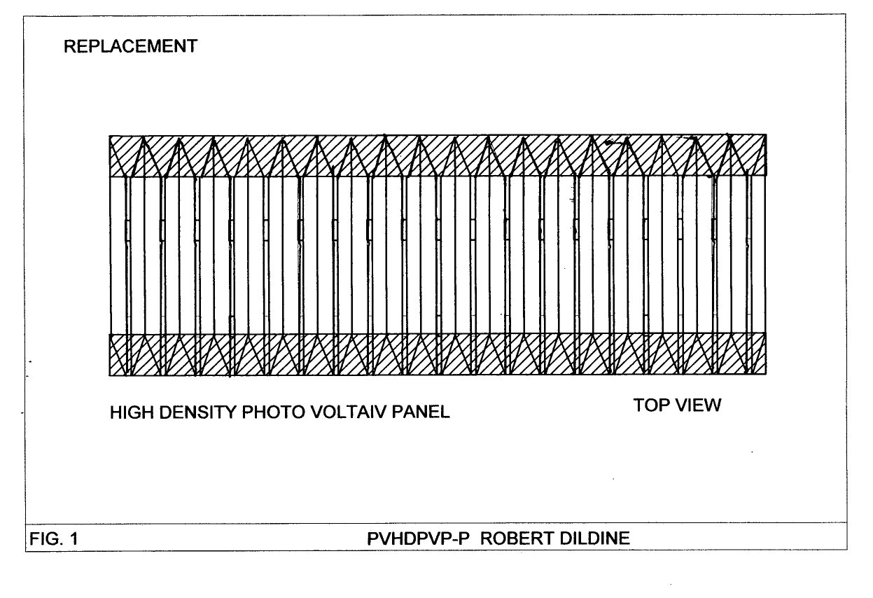

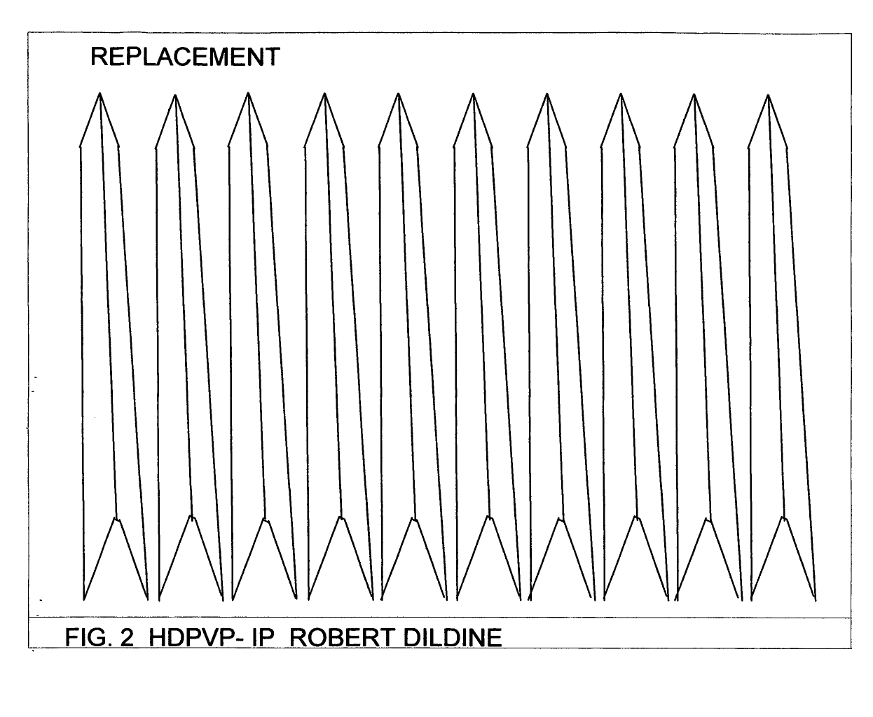

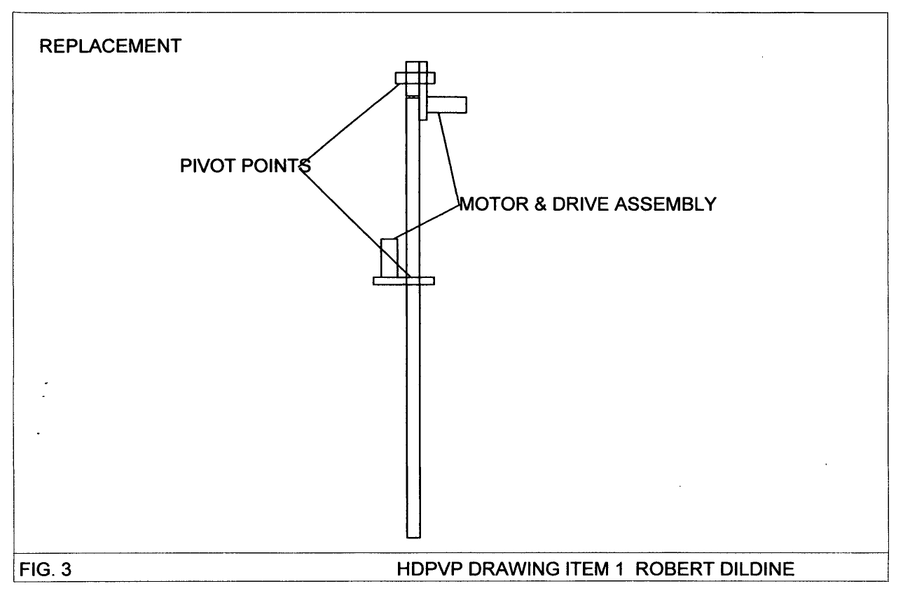

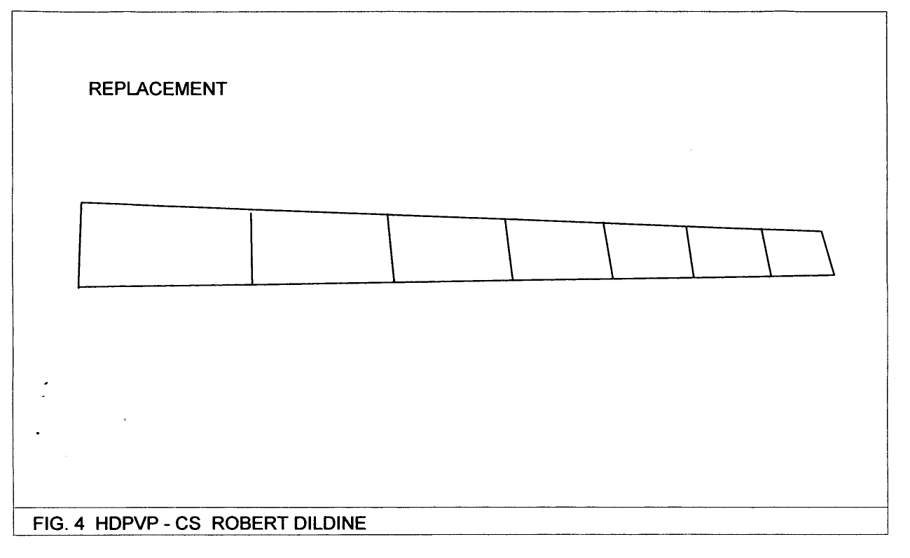

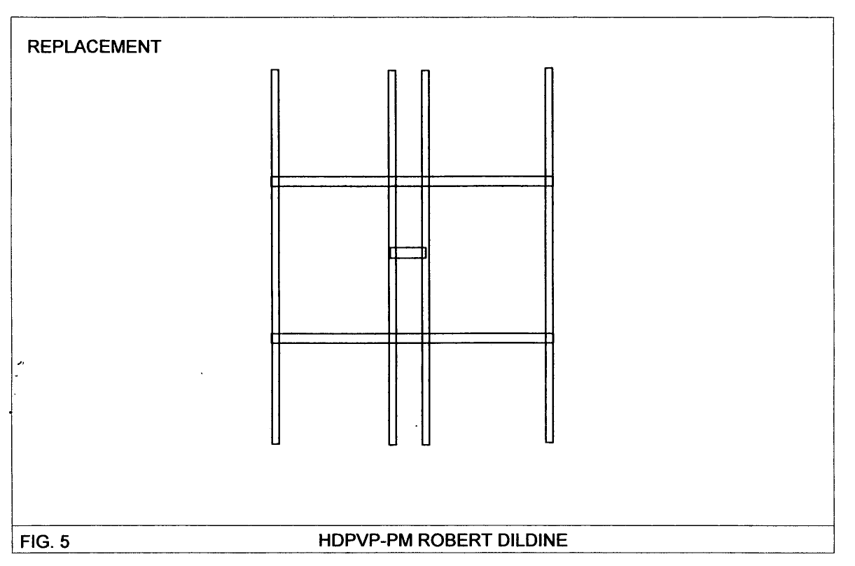

This is accomplished by the arrangement of the individual solar cells and their orientation to the source or the sun is disclosed. The invention gives the optimum output per footprint area by two concepts; maintaining solar alignment to the array and cell arrangement in the array. Essentially cell output decreases as its alignment approaches parallel to the sun but there is a point where the angle is optimal like 75 degrees and the cells would be arranged at 15 degrees from normal to the sun.

### PRIOR PUBLICATION

U.S. 61/951,982

### BACKGROUND OF THE INVENTION

### Problem Solved

It increases the power output of solar arrays or panels per area.

Current arrays or panels including those which have a solar position tracking ability do not optimize the power available per footprint area.

The invention gives the best possible output per footprint area by two concepts; maintaining solar alignment to the array and cell arrangement in the array. Essentially solar cell output decreases as its alignment approaches parallel to the sun but there is a point where the angle is optimal like 75 degrees and the cells would be arranged at 15 degrees from parallel.

### DETAILED DESCRIPTION OF THE INVENTION

As stated above, it increases the power output of solar arrays or panels per area. The invention claimed here solves this problem.

A solar cell has a varying output per orientation to the sun. When maintaining an orientation to the sun in conjunction with other cells a higher output is generated per footprint area.

The claimed invention differs from what currently exists. Solar cells as manufactured have varying outputs due to their designed chemistry and physics. The implementation of the alignment system will give a consistently higher output per footprint area of the panel regardless of cell type.

This invention is an improvement on what currently exists. Solar cells as manufactured have varying outputs due to their designed chemistry and physics. The implementation of the alignment system will give a consistently higher output per footprint area regardless of cell type.

An array of cells with solar tracking ability will have optimum output per cell but this is not optimal per footprint area.

The invention gives the optimum output per footprint area by three concepts; maintaining solar alignment to the array, cell arrangement in the array or panel and the arrangement adds depth. Essentially cell output decreases as its alignment approaches parallel to the sun but there is a point where the angle is optimal like 75 degrees and the cells would be arranged at 15 degrees from normal to the sun.

Also, it can produce Portable electric generator.

### The Version of the Invention Discussed Here Includes:

1. Tracking assembly; computer driven or sensor driven two axis arms that tracks the suns position per day and per hour.
2. Solar cells in an array or panel.
3. Cell tray or cell mount

### Relationship Between the Components:

Item 1 tracks and maintains item 2's alignment and item 3 holds item 2 and connects it to item 1.

### How the Invention Works:

The tracking system updates the alignment of the array so the sun will essentially be perpendicular to the array. Item 3 will hold the cells in a fixed position on the array. The cells will convert sunlight to electrical power.

Item 1 has two axes of operation. One axis is the suns daily position north-south. The other axis is the daily time position; east-west.

### How to Make the Invention:

Item 1 has a rotating pole supporting a pivot connected to the panel. There may be a COTS availability. Item 3 has several possibilities. Current prototype consists of sheet metal, fabric and photo voltaic cells. The cells are glued to fabric which enhances their strength. The sheet metal is bent to thirty degrees. The bent sheet metal pieces are attached to each other forming the interior of the panel. The fabric and cells are glued to the sheet metal. The cells are then soldered together to complete the panel interior. The cells would be ‘fifteen’ degrees from perpendicular and arranged in alternating V patterns. The cells would be wired prior to the insertion into the panel's interior.

The targeting portion of the system has variations; sensor driven, computer driven, or hand set. The hand set option would use simple optics for position and would require continual updates throughout the day. In all systems a feedback loop would be required.

There is some latitude such as arranging each cell but it would not be cost effective. There is one option for small systems where item 1 would not exist. Items 2 and 3 could be used for small applications like a CD player or a radio.

### How to Use the Invention:

The idea would be used for individual homes or a solar farm. The smaller system would be used for smaller electronics like a CD player or a radio or a battery charger.

Additionally: The idea produces electricity more effectively so the range of applications is broad.

Also, it can create: Portable electric generator.

### IMAGE DIRECTORY

1. Drawing of photo voltaic panel

2. Picture of internal panel under construction

3. Drawing of director

4. Picture of a string of cells

5. Drawing of frame to mount panels to director

1. A simple form high density photovoltaic panel consists of cells which are connected side to side, the cells are then rotated toward each other forming ‘V’ shapes or ‘A’ shapes, this space gained by the cell rotation reduces the footprint area taken by a flat cell, the footprint area now contains more cells which individually have a lower output but the lower output multiplied by the number of cells in the footprint area yields an overall higher output.

2. A high density photovoltaic panel can consist of cells, a string of cells or panels which are rotated and form V-shape groups with additional V-shaped groups forming a desired panel or array assembly while maintaining desired electrical properties in these groups thereby increasing the output of the area to multiple of a flat cell or panel or array.

3. A high-density photovoltaic panel is built with a variety cells which are rotated and maintain ‘contact’ distance with other cells in the same panel or array this would form ‘V’ shapes of cells and would in effect increase the number of cells per footprint area of the panel or array.

4. The amount of cell rotation is limited by the physics and chemistry of the cell as proven by multiple experiments, there is a limit to rotation.

5. A known experimental of cells rotated 75° has proven to output 70% of maximum capacity but at 75%, 1½ ‘V’ shapes can fit into the area of one cell and effectively increase output to (3×0.7=) 2.1 times the single cell area of a flat cell.

6. Cells can be tilted varying amounts yielding varying outputs—past a certain point of cell rotation it becomes necessary for the panel or array to track the sun's position therefore panel directors become necessary for some panels or arrays.
